(19) United States
(12) Patent Application Publication
(10) Pub. No.: US 2020/0235435 A1
(43) Pub. Date: Jul. 23, 2020

(54) Energy Storage System

(71) Applicant: TDK Electronics AG, München (DE)

(72) Inventors: Stefan Köstner, Donnerskirchen (AT); Franz Rinner, Deutschlandsberg (AT); Stefan Obermair, Stainz (AT); Masahiro Oishi, Deutschlandsberg (AT)

(21) Appl. No.: 16/607,129

(22) PCT Filed: May 24, 2018
(86) PCT No.: PCT/EP2018/063679

§ 371 Date: Oct. 22, 2019

(30) Foreign Application Priority Data
May 31, 2017 (DE) 10 2017 111 972.8

(51) Int. Cl. H01M 10/0585; H01M 10/04

(52) U.S. Cl. CPC H01M 10/0585; H01M 2220/30; H01M 10/0436

(57) ABSTRACT

An energy storage system is disclosed. In an embodiment, an energy storage system includes a layer stack with a first electrode layer, a second electrode layer and an electrolyte layer between the first and second electrode layers, a first electrode located in the first electrode layer, a second electrode located in the second electrode layer and an electrolyte formed in the electrolyte layer, wherein the electrolyte is a solid.

This patent application is a national phase filing under section 371 of PCT/EP2018/063679, filed May 24, 2018, which claims the priority of German patent application 102017111972.8, filed May 31, 2017, each of which is incorporated herein by reference in its entirety.

### TECHNICAL FIELD

The invention relates to energy storage systems, e.g., for electrical devices, with small dimensions and high energy density.

### BACKGROUND

Energy storage systems in electrical devices serve to supply electrical circuits with electrical energy independently of an external power supply.

Conventional portable electrical devices may, for example, be battery-powered or storage battery-powered. Capacitors are available for short-term energy supply.

A problem with known energy storage systems is, for example, the low energy density thereof.

### SUMMARY OF THE INVENTION

Embodiments provide an improved energy storage systems.

Various embodiments provide an energy storage system comprising a layer stack with a first electrode layer, a second electrode layer and an electrolyte layer between the electrode layers. A first electrode is formed in the first electrode layer. A second electrode is formed in the second electrode layer. An electrolyte is formed in the electrolyte layer. The electrolyte is a solid.

The use of a solid electrolyte in an energy storage system renders the energy storage system virtually maintenance-free, since no liquid electrolytes are contained therein, which may, for example, leak out or release gas. Furthermore, such an energy storage system, which may, for example, consist wholly of solid materials without liquid constituents, is temperature-resistant and less highly flammable. This makes it particularly readily usable in portable devices such as, for example, portable consumer goods. Furthermore, the high heat resistance ensures that conventional processing steps such as, for example, the soldering in a reflow soldering process may proceed without particular consideration for the energy storage system.

In addition, such energy storage systems are producible in virtually any desired form. Since their constituents may consist of thin layers, the overall height of such an energy storage system may be extremely small. The energy density of such a solid-state energy storage system is therefore increased significantly compared with conventional batteries or storage batteries.

It is possible for the energy storage system additionally to have a first active layer and a second active layer. The first active layer may be arranged between the first electrode layer and the electrolyte layer. The second active layer may be arranged between the electrolyte layer and the second electrode layer. Just like the solid electrolyte, the first electrolyte layer and the second electrolyte layer are in this case permeable to ions.

The solid electrolyte is advantageously not permeable to electrons.

It is in this case possible for the energy storage system to be a solid-state battery or a (rechargeable) solid-state storage battery.

The layer stack in the energy storage system as it were constitutes a cell of the energy storage system. The energy storage system may have additional cells. The energy storage system may accordingly have one or more such layer stacks. The layer stacks are in this case combined into a block. The block provides a supply voltage.

Each layer stack in this case has a solid electrolyte between two electrode layers.

It is possible for the energy storage system to comprise one or more additional blocks of this type, wherein each of the blocks provides its own supply voltage.

It is possible for the layer stack to be connected in parallel within a block. It is moreover possible for the blocks to be series-interconnected.

It is alternatively possible for the layer stacks to be connected in series within a block.

All the blocks may be interconnected in parallel relative to one another.

It is additionally also possible for both the layer stacks within a block and the individual blocks to be connected in parallel. It is moreover possible for both the layer stacks within a block and the individual blocks to be connected in series.

The multiplicity of different combinations of series and/or parallel interconnections of individual layer stacks and individual blocks results in a multiplicity of possible ways of providing different total voltages and different capacities.

The material composition of the electrodes, the electrolytes and the active layers is in this case advantageously selected such that the energy density of the energy storage system as a whole is maximized.

While parallel and series interconnections of conventional batteries have hitherto also been possible, the selection of materials for the various constituents of a battery was substantially designed to achieve specific or maximum cell voltages.

Since the layer arrangement of the present energy storage system may, as a result of the complex possibilities for series and parallel interconnections, enable virtually any sensible supply voltage, there is no need to select materials according to their cell voltage. It is therefore possible to select the underlying materials of the individual layer stacks with regard to alternative parameters, e.g., high currents, high capacities or high energy densities.

Overall, the conventional supply voltages may thus be readily provided, while on the other hand a major growth in energy density and/or capacity and/or maximum current is possible.

In the case of a high degree of cascading, i.e., a high number of series interconnections to achieve a high output voltage, the series resistance within the energy storage system increases. The gain in performance is then greater, such that even in the case of overdimensioning, an improved energy storage system may be obtained.

Even high voltages of beyond 100 V are possible as output voltages of the energy storage system.

It is possible that there is a collecting electrode for every first or second electrode of a layer stack, the respective electrode being connected with said collecting electrode. Collecting electrodes of one or more layer stacks may comprise copper or consist of copper.

It is thus possible for the energy storage system to have a first collecting electrode on a lateral side of the layer stack and a second collecting electrode on the opposing side of the layer stack. The first collecting electrode is in this case connected with the first electrode of the layer stack and separated from the second electrode of the same layer stack by a dielectric material. The second collecting electrode is connected with the second electrode of the layer stack and separated from the first electrode of the layer stack by a dielectric material.

The collecting electrodes of various layer stacks within a block may accordingly be interconnected in series or in parallel. Collecting electrodes of one block may likewise be interconnected in series or in parallel with collecting electrodes of other blocks.

It is advantageous for electrodes, e.g., collecting electrodes or electrodes within the layer stack to be non-porous and non-ion-conducting. If copper is used as such an electrode material, the material may be deposited in such a way that a non-porous copper is obtained.

Dielectric material between a layer stack or one electrode of a layer stack and a collecting electrode on the opposing side may be achieved by purposeful incorporation of the dielectric material. Alternatively, insulation may be achieved by a void, which arises during production through filling with a binder. The binder is removed subsequently, for example, during a debindering and/or sintering operation.

An alternative possibility for positioning the dielectric material is edge printing based on the electrolyte material, which in the peripheral zone has no or at most only slight ion conductivity.

The outside of the energy storage system may be formed of a protective material, which, for example, constitutes a material which is conductive neither for ions nor for electrons. Alternatively or in addition, it is possible for some points of the peripheral zone of the energy storage system to be covered by the material of a collecting electrode. Thus, for example, two opposing faces of the energy storage system may in each case be covered with the material of two collecting electrodes of different potentials. The material of the collecting electrodes may in this case project beyond the edges of the covered side and with overlap with other parts, e.g., the circumferential surface.

A possible material for the solid electrolyte is LAPT (a compound comprising lithium, aluminum, titanium and phosphorus). A possible material for an active layer is LPV (a material comprising lithium, vanadium and phosphorus).

The capacity density of the energy storage system may amount to 20 Wh/l, e.g., for a cell voltage of a layer stack of 1.8 V.

Such an energy storage system may withstand temperatures of up 260° without damage and is thus well suited to being connected and interconnected in reflow processes with an external circuit environment.

In the long term, temperatures of something over 80° C. are unproblematic under sustained load.

### BRIEF DESCRIPTION OF THE DRAWINGS

Operating principles of the energy storage system and details of embodiments are explained in greater detail in the schematic figures, in which:

FIG. 1 shows a possible layout of an energy storage system;

FIG. 2 shows an energy storage system with multiple layer stacks; and

FIG. 3 shows an energy storage system with multiple blocks.

### DETAILED DESCRIPTION OF ILLUSTRATIVE EMBODIMENTS

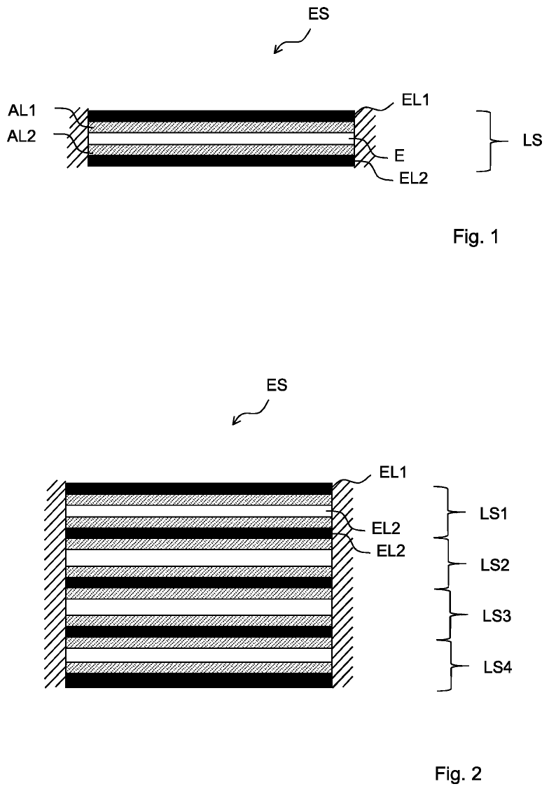

FIG. 1 shows an energy storage system ES with a first electrode EL1 in a first electrode layer and a second electrode EL2 in a second electrode layer. Between the first electrode EL1 and the second electrode EL2 an electrolyte E is arranged in an electrolyte layer.

The electrolyte E separates the two electrodes EL1, EL2 spatially from one another and is preferably ion-conductive. A voltage may be tapped at the two electrodes EL1, EL2 which may, for example, be used to operate an electrical device.

The voltage between the electrodes EL1, EL2 depends on the choice of materials. The materials may be selected such that a maximum voltage does not necessarily drop at the layer stack but rather a maximum energy density may be stored in the layer stack or a maximum current intensity may be retrieved from the layer stack.

A first active layer AL1 may be arranged between the first electrode EL1 and the electrolyte E. A second active layer AL2 may be arranged between the electrolyte E and the second electrode EL2. The two active layers AL1, AL2 are preferably permeable to the ions, which the electrolyte E likewise allows to pass through. At least one of the layers AL1, E, AL2 is not in this case transparent to electrons. Otherwise, the two electrodes EL1, EL2 would be short-circuited.

The two electrodes, the electrolyte and optionally the active layers together form a layer system LS.

FIG. 2 shows the possibility of arranging layer stacks LS, as shown, for example, in FIG. 1, together in an energy storage system, their being arranged next to one another or, as shown in FIG. 2, one above the other. For example, in FIG. 2 four layer stacks LS1, LS2, LS3, LS4 are arranged one above the other.

In principle, it is possible to interconnect layer stacks in series or in parallel. It is also possible for some layer stacks to be interconnected in series and some layer stacks to be interconnected in parallel. Parallel interconnections of layer stacks and series interconnections of layer stacks may likewise be interconnected in series or in parallel.

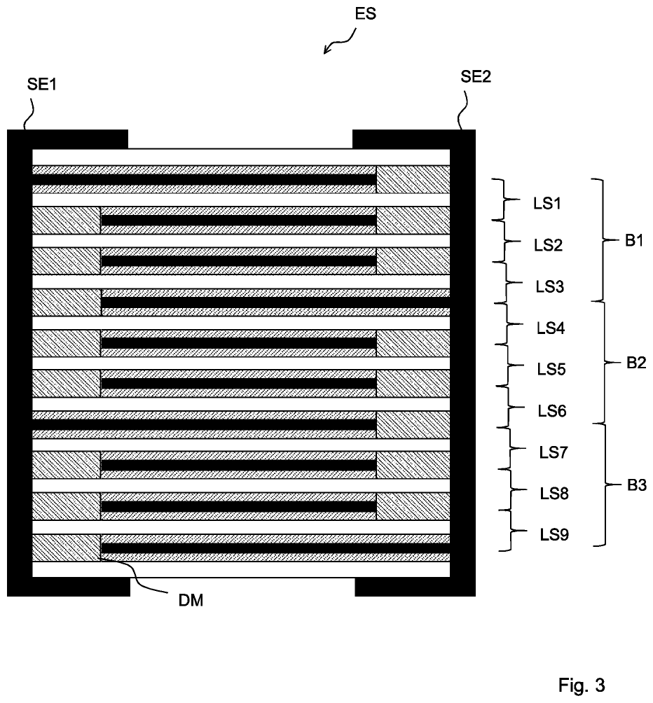

FIG. 3 accordingly shows a configuration in which a first layer stack LS1, a second layer stack LS2 and a third layer stack LS3 are interconnected to yield a first block B1. The layer stacks are here interconnected in series. A fourth layer stack LS4, a fifth layer stack LS5 and a sixth layer stack LS6 are interconnected in series to a second block B2. A seventh layer stack LS7, an eighth layer stack LS8 and a ninth layer stack LS9 are interconnected in series to a third block B3.

The first block B1, the second block B2 and the third block B3 are interconnected in parallel. Accordingly, the two collecting electrodes SE1, SE2 provide a supply voltage which corresponds to triple the voltage of an individual layer stack. The capacity of the entire energy storage system ES corresponds, in the case of the working voltage, to triple the capacity of an individual block B.

Layer stacks arranged next to one another share the material of an electrode layer. Through a suitable selection of the layer stack, it is therefore possible to save unnecessary material, e.g., electrolyte material or inert material, anode material or cathode material, compared with a corresponding, similarly acting series and/or parallel interconnection of individual components. This leads to corresponding cost, weight and space savings.

In each block B1, B2, B3 there is precisely one electrode, which is interconnected with each of the two collecting electrodes.

Every electrode layer of all the layer stacks is insulated at least on one side of a collecting electrode by a dielectric material DM. The dielectric material is preferably non-ion-conducting or at most poorly ion-conducting.

The energy storage system is not limited to the embodiments shown. Energy storage systems may furthermore have additional layers and layer stacks and collecting electrodes.

1-8. (canceled)

9. An energy storage system comprising:
a layer stack with a first electrode layer, a second electrode layer and an electrolyte layer between the first and second electrode layers;
a first electrode located in the first electrode layer;
a second electrode located in the second electrode layer; and
an electrolyte formed in the electrolyte layer,
wherein the electrolyte is a solid.

10. The energy storage system according to claim 9, further comprising:
a first active layer between the first electrode layer and the electrolyte layer; and
a second active layer between the electrolyte layer and the second electrode layer,
wherein the first and the second active layers are permeable to ions.

11. The energy storage system according to claim 9, wherein the energy storage system is a solid-state battery or a solid-state storage battery.

12. The energy storage system according to claim 9, further comprising one or more additional layer stacks, which are combined into a block which provides its own supply voltage.

13. The energy storage system according to claim 12, further comprising one or more additional blocks, each providing its own supply voltage.

14. The energy storage system according to claim 13,
wherein layer stacks of a block are connected in parallel, and
wherein the blocks are interconnected in series.

15. The energy storage system according to claim 9, wherein the first and second electrodes are in each case connected with a Cu electrode.

16. The energy storage system according to claim 9, further comprising:
a first collecting electrode on one lateral side of the layer stack and a second collecting electrode on an opposing side of the layer stack,
wherein the first collecting electrode is connected with the first electrode of the layer stack and is separated by a dielectric material from the second electrode of the layer stack, and
wherein the second collecting electrode is connected with the second electrode of the layer stack and is separated by a dielectric material from the first electrode of the layer stack.
